(19) United States
(12) Patent Application Publication
(10) Pub. No.: US 2002/0154626 A1
(43) Pub. Date: Oct. 24, 2002

(54) Telephony service system using a voice over internet protocol based on a network

(76) Inventor: Sang Y Ryu, Seoul (KR)

Correspondence Address: HARNESS, DICKEY & PIERCE, P.L.C., P.O. BOX 828, BLOOMFIELD HILLS, MI, 48303, US

(21) Appl. No.: 09/833,926

(22) Filed: Apr. 12, 2001

(30) Foreign Application Priority Data
Feb. 22, 2001 (KR) 2001-8913

(51) Int. Cl. H04L 12/66

(52) U.S. Cl. 370/352; 370/401

(57) ABSTRACT

Disclosed is a telephone service system using a VoIP based on a network, which, after globalizing VoIP numbers to be sold to individuals or companies and generating a unified system, starts VoIP numbering services and sales services, confirms whether a VoIP number of a party user, a general PSTN number(or identification number), or a VoIP number a different company provides is inputted from a specific user terminal for a telephone service wit the party user, routes the VoIP number of the party user to a communication center of a corresponding country(area) or performs call switching of the VoIP number to meet a VoIP number system a different company provides, and performs the telephone service through the corresponding country.

### BACKGROUND OF THE INVENTION

1. Field of the Invention

The present invention relates to a telephone service system using a voice over internet protocol(VoIP), and more particularly to a telephone service system using a VoIP based on a network, capable of using telephone services by providing VoIP services through sales of globally systematic telephone numbers to entrepreneurs or individuals and by providing routing services through call exchanges even though other side users use any numbers such as general public switched telephone network(PSTN) numbers, VoIP numbers other service providers provide, and so on.

2. Description of the Prior Art

In general, the internet is an open network constructed to be used in anywhere in the world by everybody by freely connecting to specific computers they want through a common protocol of Transmission Control Protocol/Internet Protocol (TCP/IP), which is used for transfers of basic text information as well as of multimedia information together with the advancement of compression technologies, including diverse services such as electronic mails, file transfers, World Wide Web, and the like.

With the use of such internet abruptly increasing in the world, including the domestic, the importance of the internet rapidly increases as a strategic tool for efficiency and productivity reconsideration throughout all fields of existing industries, and new business opportunities are incessantly created through the internet together with its areas, so entrepreneurs using the internet are gradually increasing.

That is, in recent, in connection with businesses through the internet newspaper/magazines, search services, portal services, electronic commerce businesses, and the like.

Further, in addition to the above sites, in case that industries or individuals have a computer connected to a network such as the internet and the like, in more recent, sites are increasing which provides telephone services by directly connecting computers with use of the VoIP.

Such VoIP is one of the CTI technologies of transferring voices on the Internet Protocol(IP) network, not on the existing PSTN network, and the internetphone service is a typical solution using the VoIP.

Such internet telephone service has an advantage of little or no service charge, when users use the telephone service through the internet telephone, each of users has an internet telephone program, a microphone, and the like, and uses a communication method through a drive of the internet telephone program, and a communication method through a connection to a specific web site of providing the internet telephone service with use of internet-accessible personal computer.

However, the above two methods have a drawback in that they require additional equipments in addition to the existing telephone set and there exists a user interface inconvenient for the telephone users accustomed to the general telephone sets.

Further, there exists a service available for the existing general telephone sets as an internet telephone service better than the above. Furthermore, even a case of the internet telephone service using the existing telephone sets as they are has a problem in that it is inconvenient for general users to use it since it requires complicated procedures of having an internet telephone gateway connection number, a subscriber identification number, and so on, completing connections to the internet telephone gateway by pressing the internet telephone gateway identification number, inputting the subscriber identification number, and the like.

In case of the conventional internet telephone service, the service fee is low if a internet telephone service subscriber makes calls, but the service fee is not low since the internet telephone service is not provided if receiving calls as an internet telephone service subscriber.

Further, inconvenience occurs in that the VoIp system is not globalized as well as compatibility between respective VoIP service companies does not exist since different VoIP companies have different internet telephone number systems and the VoIP numbers are different from countries with numbers of corresponding countries not supported.

### SUMMARY OF THE INVENTION

In order to solve the above problems, it is a first object of the present invention to provide a telephone service system using a voice over internet protocol(VoIP) based on a network, capable of using VoIP services by enabling users to maintain or similarly use an existing telephone number system at the same time with selling globally systematic telephone numbers by companies or individuals.

It is a second object of the present invention to provide a telephone service system using a VoIP based on a network, capable of using telephone services by providing routing services through call switching services even though other party users use any number such as a general PSTN number, a VoIP number of other companies, and the like.

It is a third object of the present invention to provide a telephone service system using a VoIP based on a network, capable of conveniently using services with complicated procedures omitted and of communicating in real time with other parties.

It is a fourth object of the present invention to provide a telephone service system using a VoIP based on a network, capable of using telephone services by providing routing services through call switching services even in case that other parties input a domain name or an electronic mail address of a corresponding user rather than VoIP numbers purchased by a company or an individual user, general PSTN numbers(or identification number), and VoIP numbers of the other companies.

In order to achieve the above objects, a telephone service system using a voice over internet protocol(VoIP) based on a network according to the present invention comprises a communication network connecting plural undefined communication lines to carry out voice and data communications therebetween; plural user terminals for carrying out communication connections with an external of providing VoIP services through the communication network, outputting to the external a purchase request signal of a specific VoIP number to be purchased by a company or an individual user according to form data provided from the external, inputting data regarding whether the sale of the VoIP number the user requests from the external is approved or rejected, purchasing the corresponding VoIP number by paying a certain amount to the external in case that the sale is approved, carrying out a member registration by outputting to the external member registration data including the VoIP number purchased by the company or individual user, a contactable PSTN number(or identification number), and a VoIP number of a different company, which the company or individual user inputs according to the form data provided by the external, and, if the user inputs either of a VoIP number, a PSTN number(or identification number), and a VoIP number of a different company for a party to whom the user wants to telephone-service, performing a telephone service through the VoIP with the party to be telephone-serviced through the communication network according to a control of the external; and a server computer for globalizing VoIP numbers to be sold to individuals or companies to generate a unified number system, outputting data regarding various information and VoIP number sales for a VoIP service to a specific user terminal which has performed a communication connection, outputting predetermined form data for VoIP number sales and a member registration according to a request of a user terminal, if a specific VoIP number and a sale request signal to be purchased from the user terminal are inputted, confirming whether the sale of the corresponding VoIP number can be sold and outputting to the corresponding user terminal data regarding whether the sale of the specific VoIP number is approved or rejected, selling the specific VoIP number the corresponding user requests if a purchase amount for the specific VoIP number sale-approved from the corresponding user terminal, inputting the VoIP number purchased by the company or individual user from the user terminal, a contactable PSTN number(or identification number), and a VoIP number of a different company and performing the member registration, if a VoIP number of a party user to be telephone-serviced from the user terminal is inputted, routing the VoIP number to a communication center at a corresponding country(area) and controlling to be telephone-serviced with the party user, and, if a general PSTN number(or identification number) or a VoIP number provided by a different company of a party user to be telephone-serviced from the user terminal is inputted, performing call switching of the VoIP number of the user to meet a number system of the corresponding country or a VoIP number system of a different company, routing the call-switched VoIP number to a communication center at a corresponding country(area) or to a PSTN network, and controlling to be telephone-serviced with the party user

Further, a telephone service method using a voice over internet protocol based on a network according to the present invention comprises steps of (1) building communication centers by countries(areas) in a server computer which provides a telephone service through a VoIP, globalizing and generating to a unified system VoIP numbers to be sold to individuals or companies, and starting a VoIP service; (2) outputting various information for the VoIP service and data regarding VoIP number sales to a specific user terminal of performing a communication connection through a communication network, and carrying out the sale of a specific VoIP number according to a request of a corresponding user; (3) inputting the VoIP number a company or an individual purchases, a contactable PSTN number(or identification number), a VoIP number of a different company, and user's personal information for the use of the telephone service using the VoIP from the user terminal and carrying out a member registration for the use of the VoIP service; and (4) confirming whether a VoIP number, a general PSTN number(or identification number), and a VoIP number a different company provides of a party user are inputted from a specific user terminal for a telephone service with the party user, routing a VoIP number of a user to a communication center of a corresponding country(area) or performing call switching of the VoIP number of the user to meet a number system of the corresponding country and a VoIP number system a different company provides and then routing the call-switched VoIP number to a communication center of a corresponding country(area) or to a PSTN network, and performing the telephone service with the party user through the VoIP.

### BRIEF DESCRIPTION OF THE DRAWINGS

The above objects and other advantages of the present invention will become apparent by describing in detail a preferred embodiment thereof with reference to the attached drawings, in which:

FIG. 1 is a block diagram for schematically showing a structure of a telephone service system using a voice over internet protocol(VoIP) based on a network according to an embodiment of the present invention;

FIG. 2 is a flow chart for showing in detail the operations of a telephone service method using a VoIP based on a network according to an embodiment of the present invention; and

FIG. 3 to FIG. 6 are flow charts for showing in detail the operations of each of the subroutines of FIG. 2.

### DETAILED DESCRIPTION OF THE PREFERRED EMBODIMENT

Hereinafter, a telephone service system using a VoIP based on a network according to an embodiment of the present invention will be described in detail with reference to the accompanying drawings.

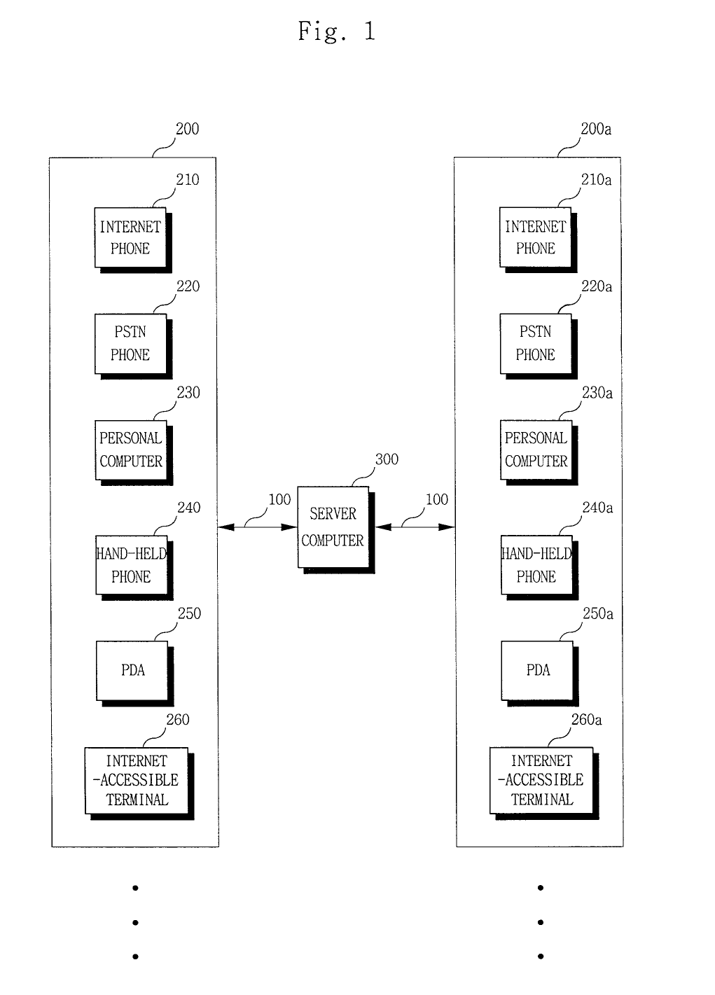

FIG. 1 is a block diagram for schematically showing a structure of a telephone service system using a voice over internet protocol(VoIP) based on a network according to an embodiment of the present invention, in which a reference numeral 200 is given to plural user terminals of requesting a telephone service and a reference numeral 200a is given to user terminals of receiving a telephone service for a convenient description.

As shown in FIG. 1, a communication network 100 is a communication network such as wire/wireless internet and the like, which connects communication lines between plural user terminals 200 and 200a and a server computer 300, described later, and performs voice and data communications related to telephone services using a VoIP therebetween.

The plural user terminals 200 perform communication connections to the server computer 300 of providing telephone services through the communication network 100 and the VoIP according to users' manipulations, output to the server computer 300 through the communication network 100 a purchase request signal for a company or an individual user to purchase a specific VoIP number according to form data provided from the server computer 300, and receive data from the server computer 300 regarding whether the purchase of the VoIP number according to the user's purchase request signal is approved or rejected.

Further, after data regarding the purchase approval of a specific VoIP number is inputted from the server computer 300, the plural user terminals 200 pay a certain fee to the server computer 300 and purchase the specific VoIP number the company or the individual user requests, perform a member registration by outputting to the server computer 300 data including VoIP numbers by companies or individuals the company or the individual user inputs, contactable PSTN numbers(or identification numbers), and VoIP numbers of other companies, according to form data provided from the server computer 300 in order to receive the VoIP services, and perform a telephone service through the VoIP by connecting to a user terminal 200a of the other party who is an object for the telephone service through the communication network 100 according to the control of the server computer 300 if any one of a VoIP number of the party the user wishes to communicate with, a PSTN number(or an identification number), and a VoIP number of the other company.

At this time, widely used for the user terminals 200 and 200a are internet phones 210 and 210a, PSTN phones 220 and 220a, personal computers 230 and 230a, cellular phones 240 and 240a, PDA 250 and 250a, internet connection terminals 260 and 260a, and the like, and mobile communication devices such as portable phones, PDA, and so on can be used in addition to the above.

The server computer 300 globalizes and creates to a unified system VoIP numbers to be sold to individuals and companies, starts telephone services using the VoIP, outputs various information for VoIP services and data regarding VoIP number sales to a specific terminal 200 which performs a communication connection through the communication network 100, outputs data of a certain form for the VoIP number sales and a membership registration according to a request of the user terminal 200, if a specific VoIP number to be purchased and a purchase request signal are inputted from a specific user terminal 200, confirms whether the sale of the corresponding VoIP number is available, and outputs to the corresponding user terminal 200 data on whether the sale of the specific VoIP number is approved or rejected.

Further, if paid for the purchase of the sale-approved specific VoIP number from the corresponding user terminal 200, the server computer 300 sells the specific VoIP number the corresponding user requests, performs the membership registration by inputting the VoIP numbers by companies or individuals, the contactable PSTN number(or identification number), and the VoIP numbers of the other companies from the user terminal 200, and, if a VoIP number of the other party user to be telephone-serviced from the user terminal 200 is inputted, controls to be telephone-serviced through a terminal of the other party user by performing routing to a communication center by corresponding country(area), and, if a general PSTN number(or an identification number) or a VoIP number other companies provide, which is a number of the other party user to be telephone-serviced through a user terminal 200, is inputted, controls to be telephone-serviced through a user terminal 200a of the other party user by performing routing to a communication center by corresponding countries or to a PSTN network after performing a call switching regarding a VoIP number of a user to meet a number system of the corresponding country(area) or a VoIP number system of the other company.

At this time, a telephone service through a VoIP provided in an application to companies from the server computer 300 is referred to as a VoIP Numbering Service(VNS), a telephone service through a VoIP provided in an application to individuals is referred to as a Personal Identification Number(PIN), and a service connecting telephone service-requesting users and the other party users through the VoIP is referred to as a VoIP Call Exchange(VCE)

Further, if any one of a VoIP number of the other party to be telephone-serviced, a PSTN number(or an identification number), and a VoIP number of other companies is inputted from a specific user terminal 200 registered as a member, the server computer 300 provides services to enable a corresponding user to receive a telephone service with the other party user in use of the VoIP by performing the call switching or the routing in case that the other party user is not registered as a member in the server computer 300.

Further, if a domain name or an electronic mail address is inputted rather than a VoIP number of the other party to be telephone-serviced, a PSTN number(or an identification number), and a VoIP number of other companies from a specific user terminal 200, the server computer 300 provides services to carry out a telephone service using the VoIP with corresponding user by performing the call switching to a number a company or an individual holding the corresponding domain name or electronic mail address has. At this time, it is preferable that the server computer 300 provides the call switching service(VCE) for the domain names to company users and for the electronic mail addresses to individual users.

That is, since the VoIP number system according to the present invention are very similar to the domain name system being used at present, the server computer 300 connects to a specific company or an individual user for the telephone service even though domain names or electronic mail addresses are inputted instead of VoIP numbers, PSTN numbers(or identification numbers), or the like from a specific user terminal 200.

Further, the server computer 300 differently establishes a VoIP number system by individuals or companies.

That is, VoIP numbers given to individuals are established in order of an area code(or identifier code), a general PSTN number(or identification number), and a country code as shown in Table 1 below (for example, a user having a PSTN number(or identification number) of 6200-6200 and living in Seoul area of Republic of Korea is given a VoIP number of 02-6200-6200-082).

TABLE 1
PIN number system

| Identifier code | Existing telephone number code | |
|---|---|---|
| Or Area code | or identification code | Country code |
| 02 | 6200-6200 | 082 |

Further, a VoIP number given to a company is established in order of a general PSTN number(or identification number), a sharp symbol(#) of a country identifier, and a country code as shown in Table 2 below(for example, a specific company user having a PSTN number(or identification number) of 6200-6200 and located in Republic of Korea is given 6200-6200 #082). At this time, the sharp symbol(#)is used as a country identifier and applied to only the companies having branches in the world, but not used for individuals.

TABLE 2
VNS number system

| Identification number code | Identifier code | Country code |
|---|---|---|
| 6200-6200 | # | 082 |

Particularly, a general PSTN number(or identification number) of a VoIP number given to a company is not differently established county by country, but established as one identical number all over the world, and, if the other users input each different country code after the general PSTN number(or identification number) and the sharp symbol of the country identifier(for example, a number 6200-6200 #001 of a company located in U.S.A. or a number 6200-6200 #081 of a company located in Japan), the server computer 300 provides a service for carrying out a telephone service to a company located in a corresponding country through the VoIP rather than through a company located in Republic of Korea.

Further, the server computer 300 provides a flash card to a user who uses VoIP services, and, if the user inputs his own ID in the flash card beforehand and then connects to the user terminal 200 which enables a telephone service using the VoIP, the server computer 300 can provide a service of enabling the user to answer his telephone from the other party users who request telephone services through the VoIP from the server computer 300.

Furthermore, the server computer 300, if a user having a hand-held phone, a PDA, and an internet-accessible terminal inputs a VoIP number given to each individual or each company, enables the user to connect to a home page the individual or the company given the corresponding VoIP number publishes or to use mailing services.

In the mean time, the server computer 300 provides a customer relationship management(CRM) service of collecting and analyzing information on different individual or company users who use the telephone services using the VoIP by country(area) at one time in the center, regardless of separately collecting and analyzing from every communication center by country information on the different individual or company users using the telephone service in use of the VoIP through a communication center established in every country in case of company users, to thereby carry out a customers satisfaction process through mother tongue services for customers regardless of products sales or locations.

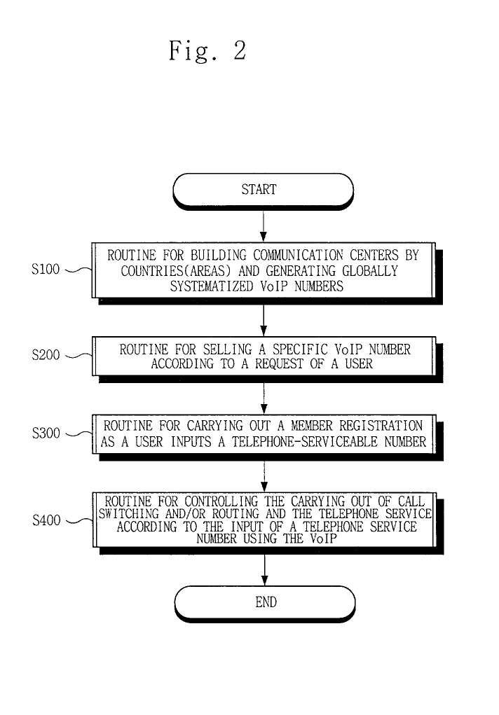

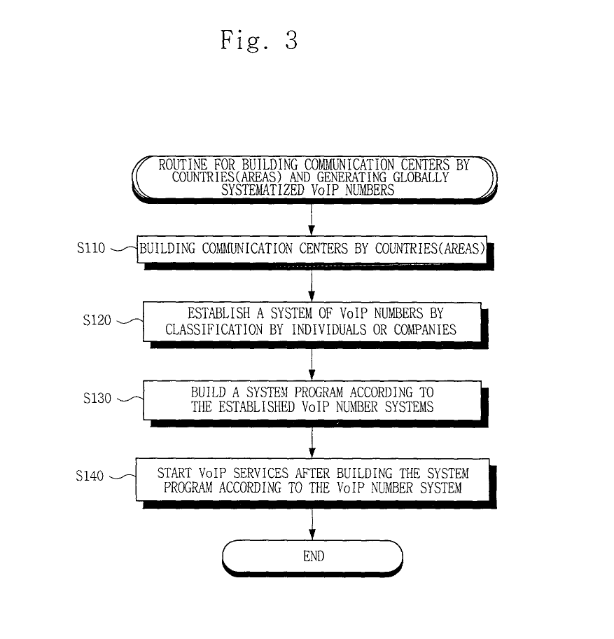

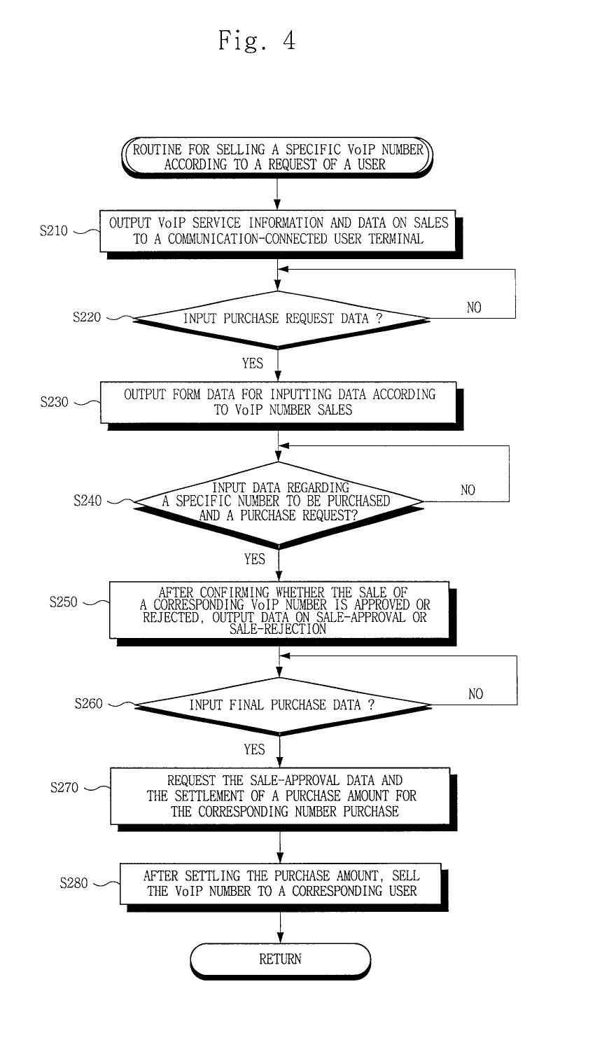

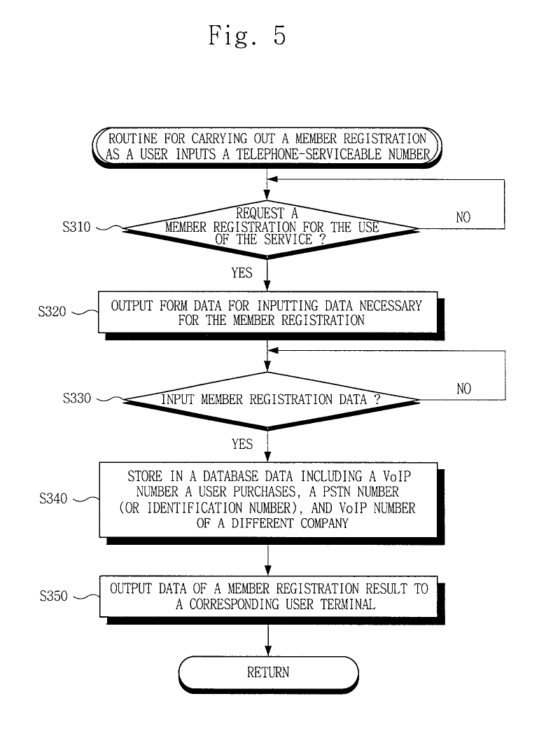

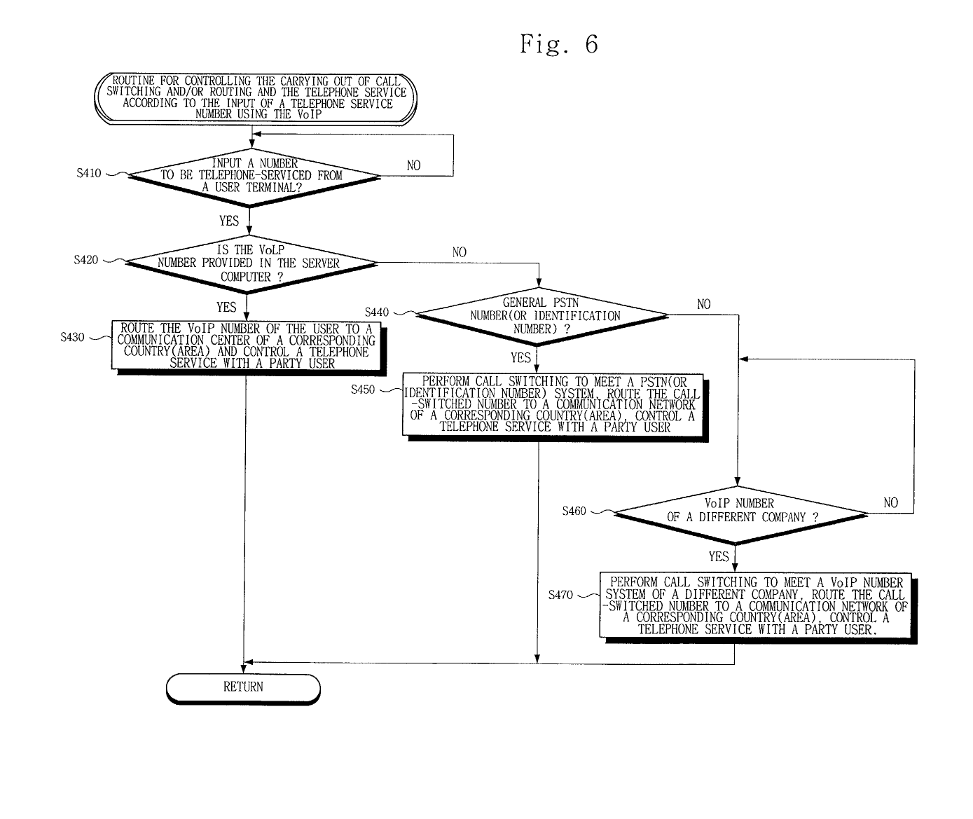

Next, a telephone service method using the VoIP based on a network having the above structure according to an embodiment of the present invention will be described in detail with reference to FIG. 2 to FIG. 6.

FIG. 2 to FIG. 6 are flow charts for showing in detail the operations of a telephone service method using the VoIP based on a network according to an embodiment of the present invention.

First of all, communication centers at every country (area) are established in the server computer 300 which provides the telephone services through the VoIP, the VoIP numbers to be sold to individual or company users are globalized to generate a unified system, and then the server computer 300 start the VoIP service(S100).

For a detailed description for the above, the communication centers at every country(area) are built in the server computer 300 in order to carry out call signal routing upon using the telephone service through the VoIP(S110).

At this time, the server computer 300, instead of directly building the communication centers for carrying out the call signal routing upon using the telephone service through the VoIP as stated above, provides telephone services through the VoIP by establishing cooperation regarding the call signal routing with companies running communication centers.

After building the communication centers at every country (area), the server computer 300 classifies VoIP numbers by individual or by company and globally establishes a VoIP number system (S120).

That is, the number system is established to be systematized, to thereby to give VoIP numbers in order of an area code(or identifier code), a general PSTN number(or identification number), and a country code to individual users, and to give VoIP numbers in order of a general PSTN number(or identification number), a sharp symbol(#), and a country code to company users.

After globally establishing the VoIP number system through the classification by individual or company, a system program is built for supporting the telephone service through the VoIP according to the VoIP number system established through the classification by individual or company (S130), and the VoIP services start online after building the system program according to the VoIP numbers by individual or company (S140).

At the same time with building the communication centers at every country(area) through the above step(S100), after globally systemizing and generating the VoIP numbers by individual or company users, the server computer 300 outputs various information for the VoIP services and data regarding the sales of the VoIP numbers to a specific user terminal 200 which performs communication connections through the communication network 100, and carries out the sales of specific VoIP numbers according to purchase requests of corresponding users (S200).

For the detailed description on the above, the server computer 300 outputs varied information on the telephone services using the VoIP and guidance data regarding the VoIP number sales according to a request of a specific user terminal 200 which carries out a communication connection through the communication network 100 (S210), and judges if purchase request data is inputted for purchasing a specific VoIP number from the corresponding user terminal 200 which has confirmed the various information regarding the confirmed VoIP service (S220).

As a result of the judgment, if the purchase request data of the specific VoIP number by individual or company is inputted from the specific user terminal 200, the server computer 300 outputs to the corresponding user terminal 200 form data for inputting data necessary for the sale of the VoIP number (S230).

Further, the server computer 300 judges if the specific VoIP number to be purchased by the corresponding user terminal 200 and the purchase request data are inputted, the server computer 300 confirms whether the specific VoIP number the corresponding user requests can be sold and outputs to the corresponding user terminal 200 data regarding whether the sale of the specific VoIP number the user requests is approved or rejected (S250).

Thereafter, the server computer 300 judges if final purchase selection data is inputted from the user terminal 200 which has confirmed data regarding the sale approval of the specific VoIP number (S260), outputs purchase approval data of the specific VoIP number to the corresponding user terminal 200 which has selected a final purchase while requesting settlement for the purchase amount of the specific VoIP number (S270).

Further, if the purchase amount of the specific VoIP number sold is inputted from the corresponding user, the server computer 300 gives the specific VoIP number to the corresponding user and enables the corresponding user to use the specific VoIP number (S280).

After carrying out the sale of a specific VoIP number according to a purchase request of a user through the above step (S200), the server computer 300 inputs a VoIP number by company or individual, a general PSTN number(or identification number), a VoIP number the other company provides, user's personal information, and so on which are inputted from each user terminal 200 by the user to use telephone services using the VoIP, and performs a member registration for using the VoIP services (S300).

For a more detailed description on the above, the server computer 300 judges if the member registration is requested for using the telephone services using the VoIP from a user terminal in a communication connection (S310).

As a result of the judgment, if the member registration is requested from the corresponding user terminal 200, the server computer 300 outputs predetermined form data for inputting data necessary for the member registration to the corresponding user terminal 200 which have requested the member registration(S320).

Thereafter, the server computer 300 judges if member registration data including a VoIP number a company or an individual user have purchased, a contactable PSTN number(or identification number), VoIP numbers of other companies, user's personal information, and so on are inputted from the corresponding user terminal 200 (S330), and stores in a database the member registration data including the VoIP number the corresponding user has inputted, the contactable PSTN number(or identification number), the VoIP numbers of the other companies, the user's personal information, and so on (S340).

Further, the resultant data of the member registration performance for the use of the VoIP services is outputted to the corresponding user terminal 200 (S350).

Now, after a company or an individual user performs the member registration for the use of the VoIP services through the step S300, the server computer 300 confirms whether either of a VoIP number of the other party user, a general PSTN number(or identification number), and a VoIP number a different company provides is inputted from a specific user terminal 200 for a telephone service with the other party's user terminal 200a, after routing the user's VoIP number to a communication center of a corresponding country(area) or performing the call switching of the user's VoIP number to meet a corresponding country(area) number system and a VoIP number system a different company provides, connects to a user terminal 200a of the other party by routing the user's VoIP number to a corresponding country(area) communication center or a PSTN network, and performs the telephone service through the VoIP (S400).

In detail for the above, the server computer 300 judges if either of the VoIP number of the other party user, the PSTN number(or identification number), and the VoIP number a different company provides for the use of the telephone services through the VoIP is inputted from a specific user terminal 200 registered as a member (S410).

Further, if either of the VoIP number of the other party user, the PSTN number(or identification number), and the VoIP number a different company provides, which is telephone-serviced, is inputted from the specific user terminal 200, the server computer 300 judges if the inputted other party user's number is a VoIP number of a system provided from the server computer 300 (S420).

As a result of the judgment, if the other party user's number inputted from the specific user terminal 200 is the VoIP number of the system provided from the server computer 300, the server computer 300 routes the user's VoIP number to a communication center of a corresponding country(area) to connect the user terminal 200 a of the other party in order for the corresponding user to carry out a telephone service with the other party user through the VoIP (S430).

However, as a result of the judgment of the step S420, if the number of the other party user inputted from the specific user terminal 200 is not a VoIP number of the system provided from the server computer 300, the server computer 300 judges if the number is a general PSTN number(or identification number) (S440).

As a result of the judgment, if the number of the other party user inputted from the specific user terminal 200 is the general PSTN number (or identification number), the server computer 300 performs the call switching of the user's VoIP number to meet a system of the PSTN number(or identification number) of a corresponding country(area), connects the user terminal 200a of the other party through the routing to a PSTN network of the corresponding country(area), and enables the corresponding user to perform a telephone service with the other party user through the VoIP (S450).

However, as a result of the judgment of the above step S440, if the number of the other party user inputted from the specific user terminal 200 is not the general PSTN number(or identification number), the server computer 300 judges if the number is a VoIP number provided from the other companies (S460).

As a result of the judgment, if the number of the other party user inputted from the specific user terminal 200 is a VoIP number provided from the other companies, the server computer 300 performs the call switching of the user's VoIP number to meet a VoIP number system a different company provides, connects the user terminal 200a of the other party through the routing to a communication center of a corresponding country (area), and enables a corresponding user to perform a telephone service with the other party user through the VoIP (S470).

In the meantime, in the above step S400, in case that a user registered as a member receives a telephone service by connecting the user terminal 200a of the other party through the use of a general PSTN number(or identification number) or a VoIP number the other company provides, instead of the use of the telephone service by using a VoIP number provided from the server computer 300, the server computer 300 receives costs according to a fee system from a corresponding user, pays the corresponding costs to a PSTN network administrator or a different VoIP company, and enables the corresponding user to freely use the telephone service with the other party user using a general PSTN number(or identification number) or a VoIP number provided by the other company without particular limits.

With a telephone service system using the VoIP based on a network according to the present invention, an effect can be obtained in that a site of providing telephone services using the VoIP can obtain regular and steady profits through the sales of globally systematized specific VoIP numbers to companies and individuals as well as through the sales of the user terminals such as internet telephones and so on, and flash cards which support the VoIP services.

Further, the present invention has an advantage of minimizing inconvenience such as telephone number changes and the like in that the company or individual users maintain an existing telephone system since the sites of providing the telephone service using the VoIP provide the call switching service which freely connects VoIP numbers company and individual users purchase, general PSTN numbers(or identification numbers), and VoIP numbers the other companies provide without any distinction between them.

Still further, the present invention has an effect in that specific companies doing worldwide business can enhance customer services more due to the providing of globally systematized common numbers together with company images since anybody can easily keep in mind with present domain names.

Furthermore, the present invention has an advantage in that companies having additional CRM services can rapidly cope with the changes of worldwide customers regardless of products sales or locations, accordingly expect new demand creations and cost reductions in customer managements, and carry out a customer satisfaction process for worldwide customers through mother tongue services.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A telephone service system using a voice over internet protocol(VoIP) based on a network, comprising:
a communication network connecting plural undefined communication lines to carry out voice and data communications therebetween;
plural user terminals for carrying out communication connections with an external of providing VoIP services through the communication network, outputting to the external a purchase request signal of a specific VoIP number to be purchased by a company or an individual user according to form data provided from the external, inputting data regarding whether the sale of the VoIP number the user requests from the external is approved or rejected, purchasing the corresponding VoIP number by paying a certain amount to the external in case that the sale is approved, carrying out a member registration by outputting to the external member registration data including the VoIP number purchased by the company or individual user, a contactable PSTN number(or identification number), and a VoIP number of a different company, which the company or individual user inputs according to the form data provided by the external, and, if the user inputs either of a VoIP number, a PSTN number(or identification number), and a VoIP number of a different company for a party to whom the user wants to telephone-service, performing a telephone service through the VoIP with the party to be telephone-serviced through the communication network according to a control of the external; and
a server computer for globalizing VoIP numbers to be sold to individuals or companies to generate a unified number system, outputting data regarding various information and VoIP number sales for a VoIP service to a specific user terminal which has performed a communication connection through the communication network, outputting predetermined form data for VoIP number sales and a member registration according to a request of a user terminal, if a specific VoIP number and a sale request signal to be purchased from the user terminal are inputted, confirming whether the sale of the corresponding VoIP number can be sold and outputting to the corresponding user terminal data regarding whether the sale of the specific VoIP number is approved or rejected, selling the specific VoIP number the corresponding user requests if a purchase amount for the specific VoIP number sale-approved from the corresponding user terminal, inputting the VoIP number purchased by the company or individual user from the user terminal, a contactable PSTN number(or identification number), and a VoIP number of a different company and performing the member registration, if a VoIP number of a party user to be telephone-serviced from the user terminal is inputted, routing the VoIP number to a communication center at a corresponding country(area) and controlling to be telephone-serviced with the party user, and, if a general PSTN number(or identification number) or a VoIP number provided by a different company of a party user to be telephone-serviced from the user terminal is inputted, performing call switching of the VoIP number of the user to meet a number system of the corresponding country or a VoIP number system of a different company, routing the call-switched VoIP number to a communication center at a corresponding country(area) or to a PSTN network, and controlling to be telephone-serviced with the party user.

2. The telephone service system as claimed in claim 1, wherein the user terminal is internet phones, PSTN phones, personal computers, hand-held phones, PDAs, and internet-accessible terminals.

3. The telephone service system as claimed in claim 1, wherein the server computer, if either of a VoIP number, a PSTN number(or identification number), and a VoIP number of a different company of a party to be telephone-serviced is inputted from a specific user terminal registered as a member, even though the party user is not registered as a member in the server computer, provides a service for performing a telephone service using the VoIP with the corresponding user through the call switching or the routing.

4. The telephone service system as claimed in claim 1, wherein the server computer, if a domain name or an electronic mail address rather than a VoIP number, a PSTN number(or identification number), and a VoIP number of a different company of a party to be telephone-serviced is inputted from a specific user terminal, performs call switching to a number corresponding to the domain name or the electronic mail address a company or an individual holds, and provides a service for performing a telephone service using the VoIP with a corresponding user.

5. The telephone service system as claimed in claim 1, wherein the server computer establishes different VoIP number systems by individuals or companies.

6. The telephone service system as claimed in claim 1, wherein the server computer establishes a VoIP number given to an individual in order of an area code(or identifier code), a general PSTN number(or identification number), and a country code.

7. The telephone service system as claimed in claim 1, wherein the server computer establishes a VoIP number given to a company in order of a general PSTN number(or identification number), a sharp symbol(#), and a country code.

8. The telephone service system as claimed in claim 7, wherein the server computer gives one worldwide identical number rather than numbers differently established country by country to the general PSTN number(or identification number) of the VoIP number given to the company, and, if different users input different country codes following a general PSTN number(or identification number) and the sharp symbol which is a country identifier, provides a service for performing a telephone service through the VoIP with a company located in a corresponding country.

9. The telephone service system as claimed in claim 1, wherein the server computer provides a flash card to a user who uses the VoIP service, and, if the corresponding user connects to a user terminal of enabling the VoIP telephone service anywhere in the world after inputting his ID in the flash card, provides a service capable of receiving the user's phone call from other users who request a telephone service over the VoIP through the server computer.

10. The telephone service system as claimed in claim 1, wherein the server computer, in case of a company user, carries out a customers satisfaction process through a mother tongue service to customers, regardless of products sales and locations, in connection with a customer relationship management(CRM) service of collecting and analyzing, at one time and at a center, information about other individual or company users who use telephone services through the VoIP service by countries, regardless of separately collecting and analyzing, at communication centers by countries, information about other individual or company users who use the telephone services over the VoIP service through the communication centers installed country by country.

11. The telephone service system as claimed in claim 1, wherein the server computer, if a user of a hand-held phone, a PDA, or an internet-accessible terminal inputs a VoIP number given by individuals or companies, enables the user to use internet connection or e-mail services of the individual or the company given the corresponding VoIP number.

12. The telephone service method using a voice over internet protocol based on a network, comprising steps of:
(1) building communication centers by countries(areas) in a server computer which provides a telephone service through a VoIP, globalizing and generating to a unified system VoIP numbers to be sold to individuals or companies, and starting a VoIP service;
(2) outputting various information for the VoIP service and data regarding VoIP number sales to a specific user terminal of performing a communication connection through a communication network, and carrying out the sale of a specific VoIP number according to a request of a corresponding user;
(3) inputting the VoIP number a company or an individual purchases, a contactable PSTN number(or identification number), a VoIP number of a different company, and user's personal information for the use of the telephone service using the VoIP from the user terminal and carrying out a member registration for the use of the VoIP service; and
(4) confirming whether a VoIP number, a general PSTN number(or identification number), and a VoIP number a different company provides of a party user are inputted from a specific user terminal for a telephone service with the party user, routing a VoIP number of a user to a communication center of a corresponding country(area) or performing call switching of the VoIP number of the user to meet a number system of the corresponding country and a VoIP number system a different company provides and then routing the call-switched VoIP number to a communication center of a corresponding country(area) or to a PSTN network, and performing the telephone service with the party user through the VoIP.

13. The telephone service method as claimed in claim 12, wherein the step(1) includes steps of:
(1-1) building communication centers at respective countries(areas) for routing a call signal when using the telephone service through the VoIP in the server computer;
(1-2) classifying by individuals or companies and globally establishing the VoIP number system in the server computer;
(1-3) building a system program for supporting the telephone service through the VoIP according to the VoIP number system established in classification by individuals or companies; and
(1-4) starting the VoIP service after building the system program according to the VoIP numbers by individuals or companies.

14. The telephone service method as claimed in claim 12, wherein the step (2) includes steps of:
(2-1) outputting various information for the VoIP service and guidance data on VoIP number sales to a specific user terminal of performing a communication connection through the communication network in the server computer;
(2-2) judging whether purchase request data for purchasing the VoIP number is inputted from a corresponding user terminal which has confirmed the various information about the VoIP service;
(2-3) outputting, if the purchase request data is inputted, predetermined form data for inputting data necessary for the VoIP number sale;
(2-4) judging if a specific VoIP number to be purchased and the purchase request data are inputted from the corresponding user terminal;
(2-5) confirming whether the sale of a specific VoIP number to be requested is available in the server computer, and outputting to the corresponding user terminal data on whether the sale of the specific VoIP number to be requested by a user is approved or rejected;
(2-6) judging if data on a final purchase selection is inputted from the user terminal which has confirmed the data on the sale approval of the specific VoIP number;
(2-7) outputting the sale approval data to the corresponding user terminal which has selected the final purchase from the server computer, and requesting the settlement of a purchase amount for the specific VoIP number; and
(2-8) selling, if the purchase amount for the VoIP number sale-approved from the corresponding user is received, the specific VoIP number the corresponding user requests.

15. The telephone service method as claimed in claim 12, wherein the step(3) includes steps of:
(3-1) judging if a member registration for the use of the telephone service through the VoIP is requested from a user terminal to the server computer;
(3-2) outputting to a corresponding user terminal of requesting a member registration predetermined form data for inputting data necessary for the member registration;
(3-3) judging if member registration data including a VoIP number a company or an individual user purchases, a contactable PSTN number(or identification number), a VoIP number of a different company is inputted from a user terminal;
(3-4) storing member registration data including a VoIP number, a contactable PSTN number(or identification number), and a VoIP number of a different company, which are inputted from a corresponding user, in a database; and
(3-5) outputting to a corresponding user terminal data on a result of a performance of a member registration for using the VoIP service.

16. The telephone service method as claimed in claim 12, wherein the step(4) includes steps of:
(4-1) judging if either of a VoIP number of a party user, a PSTN number(or identification number), and a VoIP number of a different company for the use of a telephone service through the VoIP is inputted from a specific user terminal registered as a member;
(4-2) judging if a party user's number inputted from a specific user terminal is a VoIP number of a system provided from the server computer;
(4-3) routing, if the party user's number inputted from the specific user terminal is a VoIP number of the system provided from the server computer, the user's VoIP number to a communication center of a corresponding country(area) to carry out a telephone service with the party user through the VoIP;
(4-4) judging whether the party user's number is a general PSTN number(or identification number) if the party user's number inputted from the specific user terminal is not a VoIP number of the system provided from the server computer as a result of the judgment of the step(4-2);
(4-5) performing call switching of a user's VoIP number, if a party user's number inputted from a specific user terminal is a general PSTN number(or identification number), to meet a PSTN number (or identification number) system of a corresponding country (area), routing the call-switched VoIP number to a PSTN network of the corresponding country(area) to carry out a telephone service with the party user through the VoIP;
(4-6) judging, if the party user's number inputted from the specific user terminal is not a general PSTN number(or identification number) as a result of the judgment of the step(4-4), whether the party user's number is a VoIP number of other companies; and
(4-7) performing the call switching of the user's VoIP number, if the party user's number inputted from the specific user terminal is a VoIP number of a different company, to meet a VoIP number system of the company to carry out an telephone service with the party user through the VoIP.

17. The telephone service method as claimed in claim 12 or claim 16, wherein the step(4), in case that a user registered as a member are telephone-serviced to a party user by using a general PSTN number(or identification number) or a VoIP number provided by a different company rather than a VoIP number provided by the server computer, receives costs according to a billing system from a corresponding user, pays corresponding costs to a PSTN network administrator or to a different VoIP company, to thereby enable the corresponding user to freely use the telephone service with a party user using a general PSTN number(or identification number) or a VoIP number a different company provides without a particular limitation.
